(19) United States
(12) Patent Application Publication
(10) Pub. No.: US 2005/0021445 A1
(43) Pub. Date: Jan. 27, 2005

(54) Systems and methods for augmenting the information content of financial trading protocol messages

(76) Inventor: Marshall Caro, Greenwich, CT (US)

Correspondence Address: BAKER & BOTTS, 30 ROCKEFELLER PLAZA, NEW YORK, NY, 10112, US

(21) Appl. No.: 10/668,516

(22) Filed: Sep. 23, 2003

Related U.S. Application Data
(60) Provisional application No. 60/489,872, filed on Jul. 24, 2003.

(51) Int. Cl. G06F 17/60

(52) U.S. Cl. 705/37

(57) ABSTRACT

Systems and methods are provided for inducing transactions between buying and selling parties in the electronic commerce of financial instruments. An electronic messaging platform is used to receive transaction proposals that are formatted according to financial industry protocols. The transaction proposals are sent as electronic messages to prospective counterparties. A person-person contact link is attached to each sent transaction proposal message. In response to activation of the person-to-person contact mechanism on a particular transaction proposal by any recipient, the system sets up an instant messaging session between the sender and the recipient. The instant messaging session may additionally be open or accessible to members of pre-designated coverage teams associated with the sender and/or the recipient. The information content of protocol-governed messages can also can be augmented by attaching additional information files to the messages. Electronic messages with attachments are marked for distinctive visual display. A recipient may view an attachment by activating a navigation link embedded in the distinctive visual display.

### FIELD OF THE INVENTION

The invention relates to the electronic trading of equity and other financial instruments. In particular, the present invention relates to systems and methods for conveying information amongst parties engaged in trading.

### BACKGROUND OF THE INVENTION

The public financial and equity trading markets such as the public New York Stock Exchange are open to any number of participants. Market participants can buy or sell public securities by placing orders, for example, on the floor of the public exchange. By the auction rules of the public exchanges, buy and sell orders placed on the floor are matched by price on a first come first served basis irrespective of the size of the orders. Individual parties do not have a choice of the counter party or parties at the other end of their transactions. Market participants also may buy or sell securities from parties of their choice through private arrangements away from the floor of the exchange. The private arrangements allow agreeable parties to transact, for example, large blocks of securities, at negotiated prices without interference or disruption from the trading activity of other parties on the floor of the public exchange. Broker/dealers are usually involved in finding or matching the two agreeable parties. Often the agreeable parties are large institutional clients.

A broker/dealer marketing a particular offer to buy or sell a block of securities first has to make other potentially interested institutional clients or parties aware of the offer. These potentially interested parties can be numerous and geographically diverse. Further, the particular offer may be open only for a short time. Therefore, the particular offer must be advertised quickly in real time. Broker/dealers trading in securities often use a standard networked computer system to electronically broadcast “indication of interest” (IOI) messages to market their particular offers to other parties. An exemplary computer network system for broadcasting IOI messages is the AutEx system, which is provided commercially by the Thomson Financial Company of 195 Broadway, New York N.Y. 10007.

The AutEx system is widely accepted and used in the financial industry as a trade-messaging platform. Block equity traders use AutEx to deliver IOI messages and electronic orders for listed, NASDAQ/OTC, ADR, and Ordinary and Convertible securities. The AutEx system delivers these messages for real-time display at the trading desks of all connected parties. Every day, about a million messages may be transmitted between buyers and sellers of securities.

The message sizes allowed in the AutEx system are limited by design with regard to the capacity of the system to receive, transmit, and effectively display messages amongst the large number of users. Accordingly, the format of the IOI messages on the AutEx system is standardized as a line of alphanumeric text. Minimal information that is necessary to identify the offer is included in the text. A standard format IOI message specifies the offer side (buy or sell), the security symbol, and the relative size of the block of securities offered (e.g., small, medium or large). In addition to the standard format IOI message, the AutEx system also allows two additional kinds of fixed-format messages. One additional kind is “a trade advertisement”, which is limited to a line of text reporting a completed trade. A second additional kind is a “super message”, which consists of free text that is limited to no more than 8 lines of 40 characters each.

Other industry standards or protocols are under development for the broader exchange of financial trading information. For example, Financial Information Exchange (FIX) is an evolving public-domain specification or protocol developed specifically for the electronic exchange of information relating to securities transactions. A version of a FIX protocol covers, for example, order routing and execution reporting, and post trade allocations in addition to the AutEx-type IOI messages. Implementation of electronic communications under FIX requires institutions and broker/dealers to replace or upgrade computer equipment, software and other infrastructure associated with their presently installed AutEx systems. A few institutions have adopted the FIX protocols for their individual Order Management Systems (OMS). These individual OMS systems, however, are local, and also are often mutually incompatible or unsuited for industry-wide linked communications.

The fixed format messaging systems allow rapid dissemination of data, for example, IOIs, but otherwise do not allow direct interaction between market participants to advance a transaction. A party, however, may find it useful to obtain clarifications or negotiate before committing to a transaction based on the limited information, for example, in an IOI. Thus, person-to-person contact can be beneficial in advancing business decisions and transactions. However, use of conventional means of person-to-person communication such as telephones is disruptive and not effective in the fast paced electronic trading markets of today.

Consideration is now being given generally to ways for increasing the amount of information carried by protocol constrained trading messages. In particular, attention is directed to ways of providing person-to-person information exchanges in a manner, which is compatible with the fast pace of trading in the financial and equity markets.

### SUMMARY OF THE INVENTION

In accordance with the invention, systems and methods are provided for electronic communications between broker/dealers and institutions who are engaged in trading blocks of equity or other securities. The systems and methods are designed to enhance or augment the information content of electronically transmitted trading messages (e.g., IOIs, super messages, etc.) whose alphanumeric display size is limited or fixed by industry protocols.

Opportunities for person-to-person contact are provided for communications between interested parties to increase the information available with fixed-format trading messages. Additional information including user-selectable navigation links (e.g., HTML links) that lead to the person-to-person contacts are embedded in the trading messages. The person-to-person contacts may be in the form of instant messaging sessions between interested parties or individuals.

In one embodiment, a system web site is established on a computer network linking market participants who may include, for example, salesmen at broker dealers and traders at institutional clients. The parties interact through the web site. The parties' trading messages (e.g., IOIs and responses) are displayed on web site pages accessible to the message addressees. A message addressee or recipient may initiate an instant messaging session with the sender of a trading message by activating a navigation link (e.g., a HTML link) embedded in the message display. The instant messaging session is made available to both parties through web page displays.

In practice, commercial organizations often use a team of individuals, rather than relying entirely on single individual, to service or deal with others on a subject. For example, a team of several salesmen at a broker dealer may be assigned to serve or provide coverage to a single institutional client. Conversely, a team of traders may be assigned to service or manage, for example, trades in a single stock. In such cases, the person-to-person instant messaging session initiated between a recipient and sender of a message advantageously may be extended to include other members of a coverage team on either side.

A gateway is provided for linking the system with external messaging services (e.g., AOL, Yahoo, MSN, etc.). This gateway may be utilized, for example, to set up instant messaging sessions with external parties.

The trading messages and instant messaging sessions are provided in real-time by updating the web page displays. A sortable database of the displayed messages and/or instant messaging session transcripts also is maintained. Participants may request and view historical data through the web site.

In addition or as an alternate to the instant messaging feature, the system may allow a sender to attach additional information files to protocol messages (e.g., IOIs), while preserving the standard formatted message text size for display. A sender may attach additional information files to a message using, for example, a suitable data entry tool that may be provided for the purpose. The system embeds suitable user-selectable navigation links (e.g., HTML links) leading to the attachments in the displayed messages. The protocol message displays are marked (e.g., by a color code) to indicate the presence of attachments. A recipient may access or view an attachment by activating the navigation link embedded in a marked message.

### BRIEF DESCRIPTION OF THE DRAWINGS

Further features of the invention, its nature and various advantages will be more apparent from the following detailed description, taken in conjunction with the accompanying drawings, in which like reference characters refer to like parts throughout, and in which:

FIGS. 1a and 1b illustrate Internet and non-Internet arrangements, respectively, for a messaging system, in accordance with embodiments of the present invention.

FIG. 2 is a flow chart of the illustrative steps involved in providing person-to-person contact between users to augment the information in trading messages, in accordance with the present invention.

FIG. 3a and 3b show illustrative web page displays of trading messages available to users in accordance with the present invention.

FIG. 4 shows an exemplary preference editor tool for customizing web page displays of trading messages in accordance with the present invention.

FIGS. 5a and 5b show illustrative web page displays of trading messages and instant messaging session titles in accordance with the present invention.

FIG. 6 shows an exemplary listing of canned message terms available to users for constructing messages in accordance with the present invention.

FIGS. 7a and 7b show another pair of illustrative web page displays of trading messages and a first message of an instant messaging session between two parties, in accordance with the present invention.

FIGS. 8a and 8b are illustrative web page displays of the beginning of the instant messaging session between the two parties of FIGS. 7a and 7b, in accordance the with present invention.

FIGS. 9a and 9b are illustrative web page displays during the progress of the instant messaging session of FIGS. 8a and 8b, in accordance with the present invention.

FIGS. 10a and 10b are illustrative web page displays of the instant messaging session of FIGS. 8a and 8b on its termination, in accordance with the present invention.

FIG. 11a is an illustrative screen display of an external-messaging service showing an exemplary message from an external party for communication with the system of the present invention.

FIG. 11b is an illustrative web page display showing the external message of FIG. 11a displayed in a chat directory of a system user, in accordance with the present invention.

FIG. 11c is an illustrative web page display showing an instant messaging between the external party (FIG. 11a) and the system user of FIG. 11b, in accordance with the present invention.

FIG. 11d is an illustrative web page display showing the transcript of the instant messaging session of FIG. 11c after its termination, in accordance with the present invention.

FIG. 11e is an illustrative screen display of the external-messaging service of FIG. 11a showing the transcript of the instant messaging session of FIG. 11c after its termination.

FIG. 12 is a flow chart of the illustrative steps involved in augmenting the information carried in protocol trading messages by attaching an additional information file to the messages, in accordance with the present invention.

FIG. 13 is an exemplary tool for generating an information attachment to a trading message, in accordance with the present invention.

FIG. 14 is an illustrative web page display showing the display of the trading message of FIG. 13, which is marked (e.g., by a bold font) to indicate the presence of the information attachment, in accordance with the present invention.

FIG. 15 is an illustrative display of the information attachment of FIGS. 13 and 14, presented to user, in accordance with the present invention.

### DETAILED DESCRIPTION OF THE INVENTION

The present invention provides systems and methods to induce transactions in electronic commerce. In particular, the systems and methods relate to communications between two parties such as a buyer and a seller of goods in an auction-type market. The goods may, for example, be publicly traded securities or financial instruments. The parties may, for example, be broker/dealers and financial institutions that participate, for example, in trading blocks of equities or other securities. Generally, a party as referred to herein may be any participant involved in the trading process, and may be designated herein interchangeably, for example, as a participant, a buyer, a seller, an institution, a broker/dealer, a salesman, a client, a requester, a trader, or a system user. The term party is generally used refer to a single individual, but in context may be used to refer to a group of individuals (e.g., to a client coverage team).

The inventive systems and methods encourage electronic trading transactions by using electronic messaging platforms to receive and broadcast transaction proposals amongst parties and prospective counterparties, and by enabling person-to-person communications between parties interested in a specific or particular proposal. The person-to-person communications between the parties may include one or more individuals on either side.

The transmitted proposals are suitably formatted data records. The suitable data record formats may include data fields similar to those of the conventional IOI messages used in AutEx system. In addition, the transmitted data records include navigation or contact links that lead to person-to-person contact sessions.

A recipient who is interested in discussing or negotiating a particular transaction proposal, for example, before deciding to commit, may indicate an interest for more information. The recipient may indicate interest by activating the contact link in the corresponding data record. In response to a recipient's interest, the recipient and originator of the particular data record are placed in person-to-person contact. The recipient additionally may be placed in person-to-person contact with members of a designated coverage team associated with the originator.

Common communication technologies or tools that allow rapid or instantaneous person-to-person contact may be exploited for this purpose. The common communication technologies or tools include wired or wireless telecommunications networks, Internet or Intranet computer networks, and tools such as web browsers and instant messaging tools. These technologies or tools may allow the matched parties to communicate, for example, by talking, voice messaging, emailing, text messaging, chatting or conferencing.

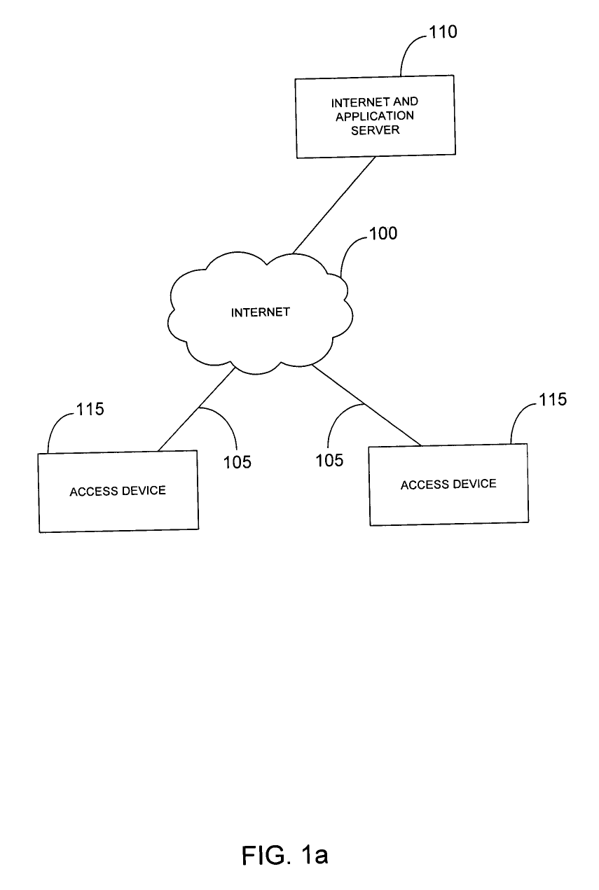

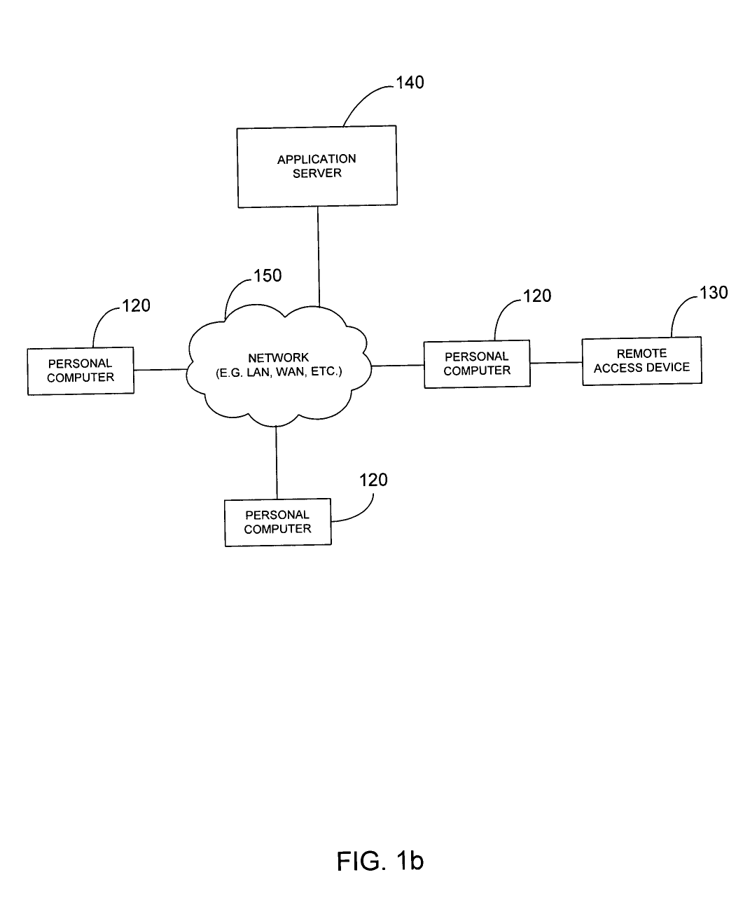

The systems of the present invention may be implemented using any suitable communications network. For example, suitable non-Internet-based client/server or peer-to-peer approach or, preferably, any suitable Internet-based approach, may be used. If desired, a combination of these approaches may be used. Illustrative Internet-based and non-Internet-based arrangements are shown in FIGS. 1a and 1b, respectively. In the illustrative Internet-based arrangement of FIG. 1a access devices 115 may be connected via links 105 to Internet 100. Access devices 115 may include any device or combination of devices suitable for providing Internet access to a user of the system. Access devices may include, for example, any suitable personal computer (PC), portable computer (e.g., a notebook computer), palmtop computer, handheld personal computer (H/PC), automobile PC, and/or personal digital assistant (PDA). The access devices may, for further example, include Internet-enabled cellular phone, combined cellular phone and PDA, ebook, set-top box (e.g., a Web TV enabled set-top box), or any other device suitable for providing Internet access.

Internet and application server 110 may be any server suitable, for example, for hosting a system web site and for providing on-line access to the system web site. Internet and application server 110 may, for example, provide one or more system web site pages to access devices 115 using one or more suitable protocols (e.g., the HyperText Transfer Protocol (HTTP) and Transmission Control Protocol/Internet Protocol (TCP/IP)). The pages may be defined using, for example, any suitable markup language (e.g., HyperText Markup Language (HTML), Dynamic HyperText Markup Language (DHTML), etc.), and include pages defined using the Extensible Markup Language (XML), JavaServer Pages (JSP), Active Server Pages (ASP), or any other suitable approaches. The pages may include scripts, computer code, or subsets of computer code, that define mini-programs (e.g., Perl scripts, Java applets, Enterprise JavaBeans (EJB) or any other suitable approaches). Internet and application server 110 may also run a database engine suitable for maintaining a database of user and message information such as, for example, Microsoft SQL Server, Oracle 8i, or any other suitable database engine. In practice, the functionalities of Internet and application server 110 may be integrated into a single server, or may be distributed across multiple servers that are interconnected via Internet 100.

Links 105 may include any transmission medium suitable for providing Internet access to access devices 115. Links 105 may include, for example, a dial-up telephone line, a computer network or Internet link, an infrared link, a radio frequency link, a satellite link, a digital subscriber line link (e.g., a DSL link), a cable TV link, a DOCSIS link, T-1 link, or any other suitable transmission link or suitable combination of such links. Different links 105 may be of different types depending on, for example, the particular type of access devices 115.

FIG. 1b shows another illustrative arrangement for a system of the present invention. In the non-Internet-based client/server arrangement of FIG. 1b, personal computers 120 (sometimes also referred to herein as access devices) are interconnected via network 150 to application server 140. Application server 140 may be any server suitable for hosting web sites and for providing users access to these web sites. Application server 140 may, for example, maintain a database of customer and item information. Application server 140 may run a suitable database engine such as, for example, Microsoft SQL Server, Oracle 8i, or any other suitable database engine. In practice, the functionality of application server 140 may be integrated into a single server, or may be distributed across multiple servers that are interconnected via network 150.

Network 150 may be any suitable local area network (LAN), wide area network (WAN), or other suitable network. Personal computers, and their interconnection via networks, are well known. Personal computers 120 may run suitable e-mail, HTTP, or other clients and client applications for providing users with access to features of the system. In still another suitable approach, personal computers 120 may run suitable Internet browsers to provide users with access to the Internet via an Internet server (not shown). If desired, one or more personal computers 120 may be accessed by remote access device 130 to provide remote access to users to the system. Remote access device 130 may be any suitable device, such as a personal computer, personal digital assistant, cellular phone, or other device with remote access capabilities.

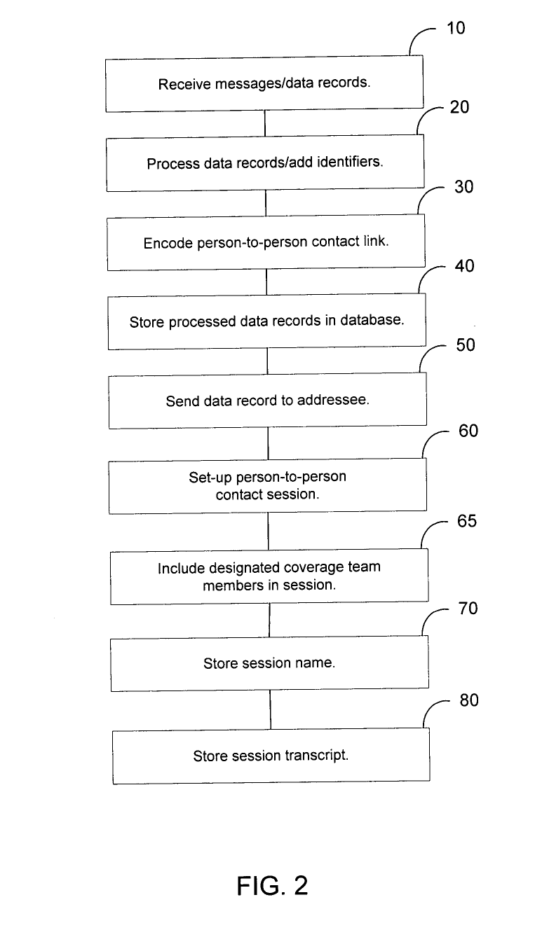

FIG. 2 is a flowchart of the illustrative steps involved in providing opportunities for person-to-person information exchanges along with the delivery of protocol-governed trading messages, and/or for providing additional information with the protocol-governed trading messages. The steps shown in FIG. 2 are only illustrative and may be performed in any suitable order. In practice, some of the steps may be omitted, and additional steps that are not shown in FIG. 2 may be included.

Some of the steps shown in FIG. 2 involve providing users with opportunities to interact with the system, performing various processes, or providing various displays. These and other steps may be performed by, for example, a client application that is programmed to generate or download screens suitable to provide such opportunities, or an Internet browser that downloads suitable “web” pages to provide such opportunities. Other steps may involve additional processing, such as searching, sorting, or other types of processing. In non-on-line arrangements, such processing may be performed by the client, a server, or distributed among peer applications, depending on the chosen system implementation and the processing requirements of such operations. In on-line arrangements, such processing may be performed by access device 115 or Internet and application server 110, depending on, for example, the processing and storage capabilities of access device 115, the chosen implementation for the markup language documents used, the processing requirements of such operations, or other factors.

The provided displays may give users (e.g., broker/dealers and block equity traders) with access to features of the implemented system using any suitable interface. A suitable interface may include, for example, graphical interface elements. Suitable graphical interface elements may include, for example, push buttons, check boxes, radio buttons, scroll bars, drop-down menus or lists, input fields or text boxes, links, or any other graphical interface element suitable to the chosen access device 115 or personal computer 120.

For purpose of clarity, the following discussion will describe various steps in the present invention as being performed by “the system” which is intended to include any suitable system, for example, any non-on-line or on-line arrangement suitable for performing the steps.

With reference to FIG. 2, at step 10, the system receives a transaction message from a user at a connected access device. The transaction message may be a transaction proposal or a response, and may be addressed to one or more system users. A transaction proposal may, for example, be an IOI message for a block equity trade that is electronically sent out by a salesman at a broker/dealer. The received transaction message is accepted by the system in the form of a data record, which includes data fields that are formatted according to industry protocols (e.g. FIX). The IOI messages may have a fixed format data fields that are similar or identical to those used in the AutEx system or under FIX protocols.

The received transaction message may include data fields giving explicit instructions or authority for substitute or additional persons to receive responses on behalf of the sender. The additional persons may, for example, be a sales coverage team at a broker/dealer. The electronic addresses of the team members may have been previously obtained and stored in the system databases. The electronic addresses may be stored, for example, as address groups. The authority for additional persons to receive responses may be pre-arranged to apply to all messages sent to the system by a sender, avoiding the need to provide instructions in every message sent out by the sender.

At step 20, the received data record is processed by the system to add suitable identifiers. The identifiers may, for example, include a time stamp indicating the time of receipt, and text or icons identifying the sender.

At optional step 30, which may be concurrent with step 20, the system adds or encodes a user-selectable contact link in some types of processed data records. For example, only IOI messages may be so encoded. The contact link may be designed to initiate a person-to-person contact session between the addressee of the transaction message and its sender. The system also may determine if a coverage team has been designated or authorized for the sender. Accordingly, the contact link may be designed to place the addressee of the transaction message in a person-to-person contact session with all members of the designated coverage team on the sender's side.

At step 40, the system stores the data record processed through step 20 and/or steps 20 and 30 in a database.

At step 50, the processed data records are electronically sent or otherwise made available to the addressee. The data record may, for example, be made available on a web page that can be viewed by the addressee. The system may present the contact link encoded in a data record using any suitable interface (e.g., HTML links, buttons, icons, etc.). The addressee may accordingly activate the contact link by, for example, clicking on a HTML link, button or icon on the web page with the displayed message data record.

At step 60, in response to an activation of the user-selectable contact link by an addressee, the system sets up a person-to-person contact session between the activator addressee and the sender. The person-to-person contact session may, for example, be an electronic instant messaging session between the two parties. The system may suitably name the instant messaging session, for example, with a name that allows the messaging parties to conveniently identify the session context.

At optional step 65, the system may determine, for example, by the nature of the contact link encoded at step 30, if other persons have been designated to receive responses for the sender. The system may accordingly enlarge the instant messaging session to place the recipient in person-to-person contact with all of the designated coverage team members on the originator's side. Step 65 may be contemporaneous or a part of step 60.

At optional step 70, the system may store the session name in a database, for example, in a chat directory list. The system may provide the users the chat directory list.

At optional step 80, the system may store a transcript of the messages in a named session in a database. The system may display or otherwise provide users with access to the transcripts of the named sessions in real time or later.

As with all steps shown in FIG. 2, steps 20-80 may be performed in any suitable order and even contemporaneously. For example, the system may receive messages from parties even as processed data records are being electronically sent to them. Steps not shown may be added and shown steps may be omitted.

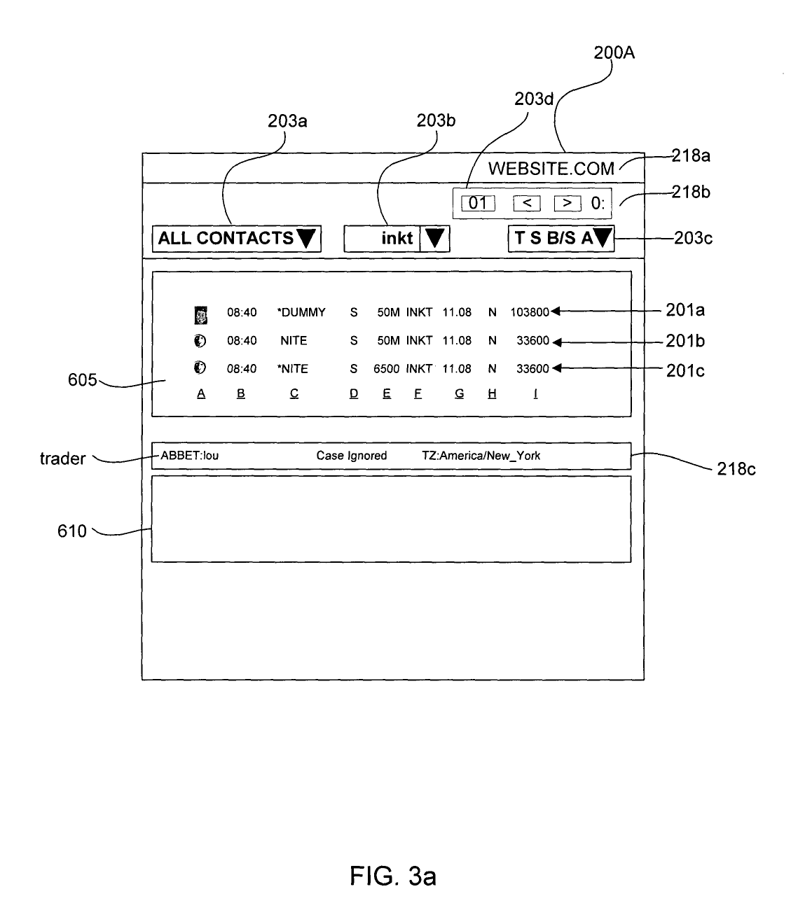

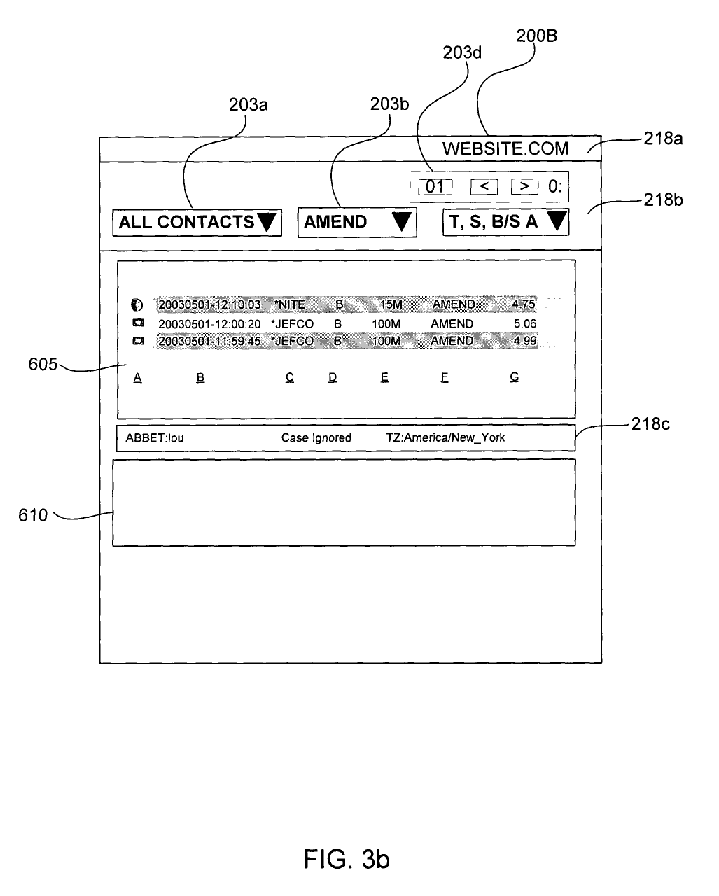

FIGS. 3-15 show illustrative web page displays that are provided to system users. These displays are described herein generally as Java Applet web pages, but may be any display suitable for the chosen system implementation (e.g., application displays, pop-up windows, or any other suitable display). Displays such as those shown in FIGS. 3-15, or portions thereof may be displayed exclusively, or may be displayed in conjunction with other displays or portions of displays.

FIG. 3a shows an illustrative Java Applet display 200A. Illustrative display 200A, as well as other displays described herein, may include one or more common portions, such as header portion 218a, interface panel 218b, window panels 605 and 610, and panel separator portion 218c. Header portion 218a may include, for example, the name given to the system by the system provider (e.g., Website.com). Panel separator portion 218c may include, for example, the name or identification of the user of the access device (e.g., Abbet: lou). Interface 218b may contain one or more menu links and or indicators that can be activated by the user to interact with the system (e.g., drop down menu boxes 203a-203d).

In one embodiment of the invention, person-to-person instant messaging sessions over the system network are coordinated or linked with the broadcasted transaction proposal data records. This embodiment utilizes networked computers, for example, installed at trading desks of users. The system may be configured to receive, process and store data records or messages from the users. The processed data records may include sets of current data and optionally include sets of historical data. The processed data records may include data fields formatted (e.g., for IOI and trade advertisements) according to suitable industry standards (e.g., AutEx or FIX protocols). The processed data records may include other data fields that provide additional information. The data records also may have links for establishing person-to-person contacts.

The processed data records are made available by the system to users over the system network, for example, through a system web site. The users may, for example, access the system web site and display or view data records at their computer terminals by employing a suitable web browser. The system may update the data record displays dynamically in real-time. The data record displays or views may be amenable to customization or organization into subsets, according to criteria that may optionally be set by a user through the web browser. Customized subsets of data records may be presented to the users on separate web pages.

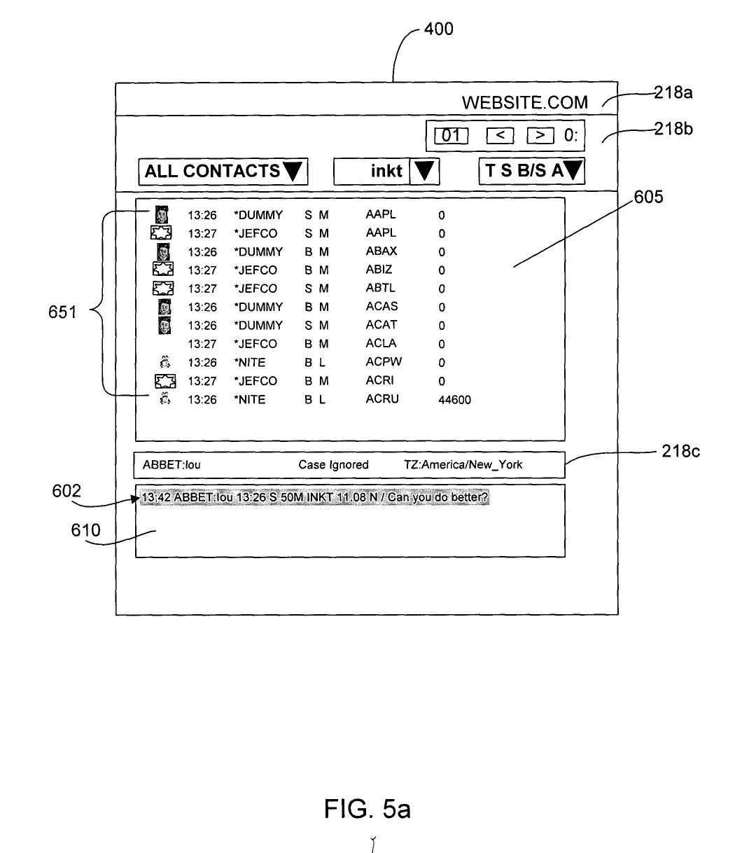

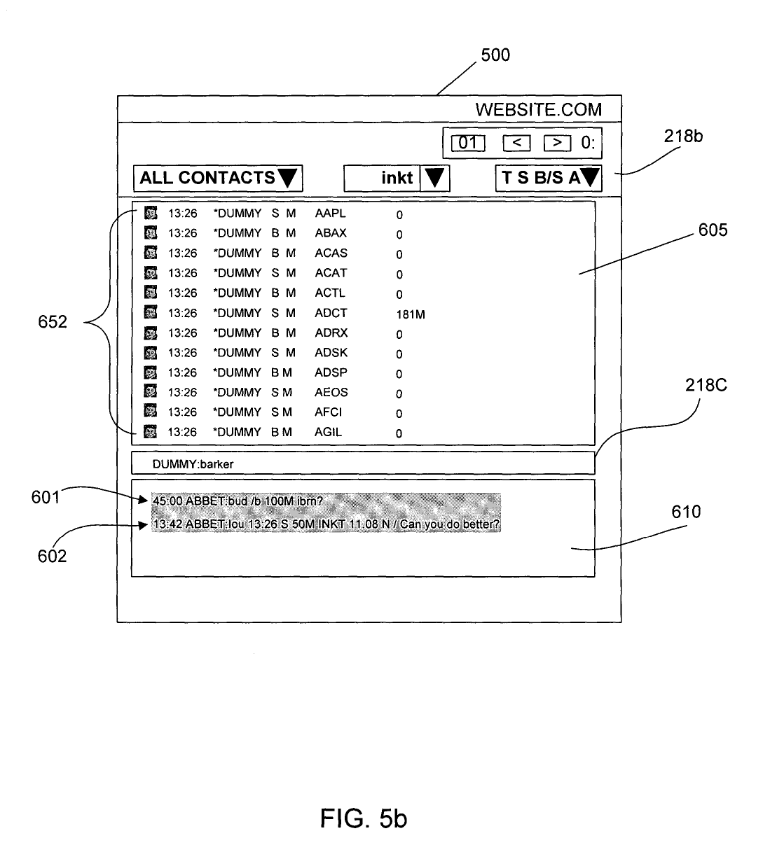

Exemplary Java Applet page 200A shown in FIG. 3a is configured to display or present select processed data records, for example, at the desk of a trader “Lou” at an institutional client “Abbet.” (See separator 218c). Panel 610 maybe used for displaying information relating to instant messaging, for example, when the person-to-person contact links are activated, as will be described below with reference to FIGS. 5-11. Panel 605 is used for displaying the select processed data records (e.g., data records 201a, 201b, and 201c). The illustrative records 201a, 201b, and 201c represent, for example, IOI messages that have been sent out by broker/dealers.

The display shown in page 200A may have been customized by trader Lou to display all IOIs related to a particular stock originating from broker/dealers in a particular select group. Web page 200A may have been customized, for example, for a particular stock symbol “INKT” and a select group of broker/dealers “ALLCONTACTS” by selecting appropriate entries in drop down menu boxes 203b and 203a, respectively.

Relevant records 201a, 201b, and 201c are displayed in panel 605. The displayed records include data fields A-I some of which are formatted according to the FIX protocol. Column D includes an entry (e.g., “S”) to indicate whether the IOI is a buy or sell order. Columns E, F, and G identify the block size, the stock symbol, and its bid/ask price, respectively. Column C includes an entry (e.g., Broker/dealers “Dummy” and “Nite”) to identify the originator of the IOI. Column A includes a visual icon or symbol to identify the originator. An asterisk prefix to the entry in column C indicates that the IOI was broadcast to all buy side recipients on the system. Column B entries indicate the time of the broadcast (e.g., GMT 8:40 hours). Column H includes a flag (e.g., flag “N”) indicating whether the IOI is agency or principal originated.

Column I is a data field with additional information, which may be useful to trader Lou in deciding whether to follow-up or pursue a particular IOI. Column I as shown on web page 200A, for example, displays a cumulative volume of daily activity in the particular stock symbol (column F) that has originated from the broker/dealers identified in columns A and C. These daily volumes may be up-dated in real-time by the system. This display of historical data may, for example, allow trader Lou at Abbet to assess at a glance the daily activity of particular broker/dealers in the symbol, and to accordingly respond to the particular IOI. The displayed data records include user-selectable links for person-to-person contact sessions with the originator of the IOI. An entire displayed data record or portions thereof may, for example, be displayed as an HTML link to a contact session.

Page 200A displays only currently valid IOIs. IOIs may become non-current or invalid, for example, by the lapse of time or by explicit cancellation by the originating broker/dealer. These invalid IOIs remain logged in the system database for historical purposes or analysis, but are automatically deleted from the real-time presentation in page 200A.

It will be understood that a user may choose alternative sets of data records for customized display. FIG. 3b shows, for example, web page 200B that is customized to display historical IOI messages. The IOI messages shown in panel 605 were received on a previous day from broker/dealers in the selected group of broker/dealers “ALLCONTACTS” relating to a stock “AMEND”. Web page 200B may have been customized to display data from the previous day by inputting a suitable entry (e.g., 1 day) in interface input field 203d. In one version of the system, data records for up to 10 previous days may be available for viewing. Exemplary web page 200B includes time-date stamp entries in column B, in addition to entries in columns A, C-G that are similar to those in corresponding columns in web page 200A.

The user preferences for one or more customized web page displays may be stored as preset templates in system memory. Use of preset templates may be advantageous for quick retrieval and display of desired views of data records. In one embodiment of the invention, each user can set viewing preferences, for example, in about 10 web page templates. Each template may be set up for a different set of symbols, broker/dealers, and protocol message parameters (e.g., IOIs, super messages, trade advertisements, buy/sell side, size, etc.). Each template also may include a sorting preference for display of data records (e.g., by name, volume, size or price).

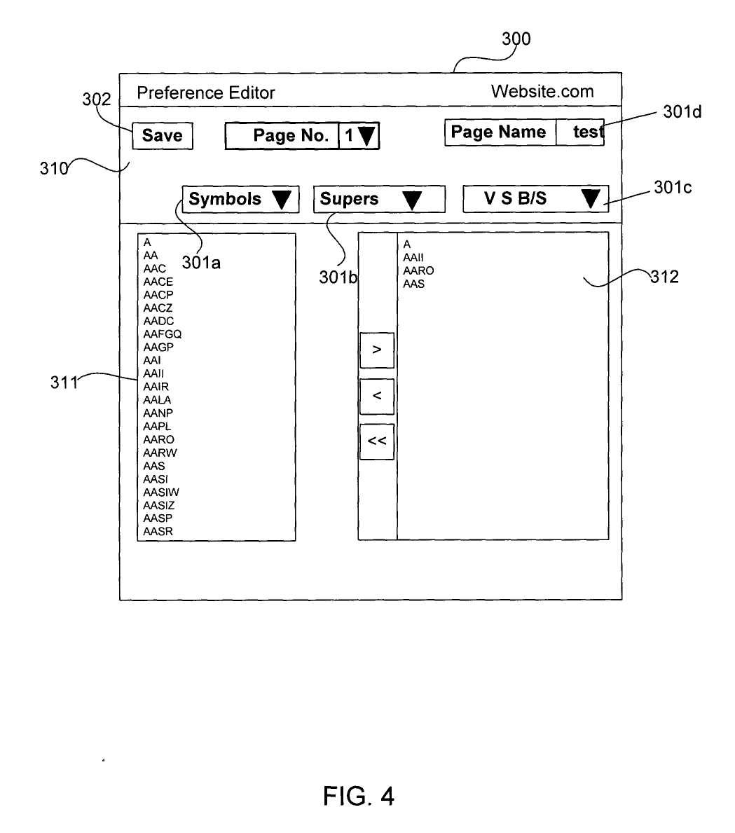

A user may set up the preset templates by using a preference editor tool provided by the system. FIG. 4 shows an input screen 300 of an exemplary preference editor tool. Interface panel 310 of the input screen 300 includes entry fields for page numbers and user selected page names. Interface panel 310 also includes drop down menus 301a, 301b, and 301c from which a user may manually select symbols, message types, and sorting types, respectively. Drop down menu 301a, for example, includes a list 311 of stock symbols from which the user may select a set of individual symbols 312 for a customized display of data records. The user may use a “SAVE” indicator 302 to store the template under the page number and name entered in input boxes 301d. Preference editor tool 300 also may be suitably interfaced and operated through other software tools. For example, the preference editor tool may be interfaced with a user's OMS so that the former can be utilized through the latter.

The availability of the data records on the system web site may be tailored according to the type of the user. In one example, IOI data records from all broker/dealers may be made available to an institutional client, while a broker/dealer may be limited to self-originated IOI data records. FIG. 5a shows, for example, web page 400 that displays IOI data records 651 from all broker/dealers to a trader at an institutional client (e.g., to Lou at Abbet). In contrast FIG. 5b shows, for example, web page 500 that displays only self-originated IOI data records 652 to a salesman at broker/dealer (e.g., to salesman “bbarker” at broker/dealer “Dummy”). Accordingly, entries in column A in web page 500 for all displayed records 652 show identical icons (i.e., the icon for the broker/dealer Dummy).

Web pages 400 and 500 also show message entries or titles in respective panels 610 (e.g., title 602, titles 601 and 602). These message entries correspond to the first message in an instant messaging session provided by the system for communications between the users. The message entries in respective panels 610, for convenience, also may be used as names or titles for the corresponding instant messaging session. The system also may provide user-selectable navigation links (e.g., HTML links) in the message/title entries (e.g., 601 and 602) by which a user can access the named instant messaging session.

The instant messaging sessions are initially set up by the system in response to a user's activation of selectable links in the displayed data records (e.g., FIG. 3a, IOI data records 201a, 201b and 201c). In one version of the system, only institutional clients may initiate person-to-person contact or communication in response to a particular IOI. This restriction on who initiates communication advantageously prevents institutional clients from being overwhelmed with communications from a slew of broker/dealers.

A user at the institutional client's desk (e.g., Lou at Abbet) may initiate communication, for example, regarding a particular IOI (e.g., FIG. 3a data record 201a), by first selecting the particular IOI display of interest, and then activating the contact link in the displayed data record. The user may activate the contact link, for example, by mouse clicking on data record. In response the system sets up an instant messaging session between the activator user and the sender of the IOI. The instant messaging session may be expanded to include other persons designated by the sender of the IOI, e.g., the members of a coverage team.

In setting up the instant messaging session the system reproduces a sufficiently identifying or relevant number of data fields of the selected data record (FIG. 3a panel 605) into panels 610 for both parties. The relevant number of data fields are reproduced in a header portion of at least the first message line. Inclusion of these data fields in the message line makes it convenient for both the sending and receiving parties to identify the context of the message. For example, message line 602 (FIGS. Sa and 5b) includes reproduced entries “S 50M INKT, 11.08 N”, which are the column D-G entries of IOI data record 201a (FIG. 3a). The system adds suitable time stamps and originator labels to line 602.

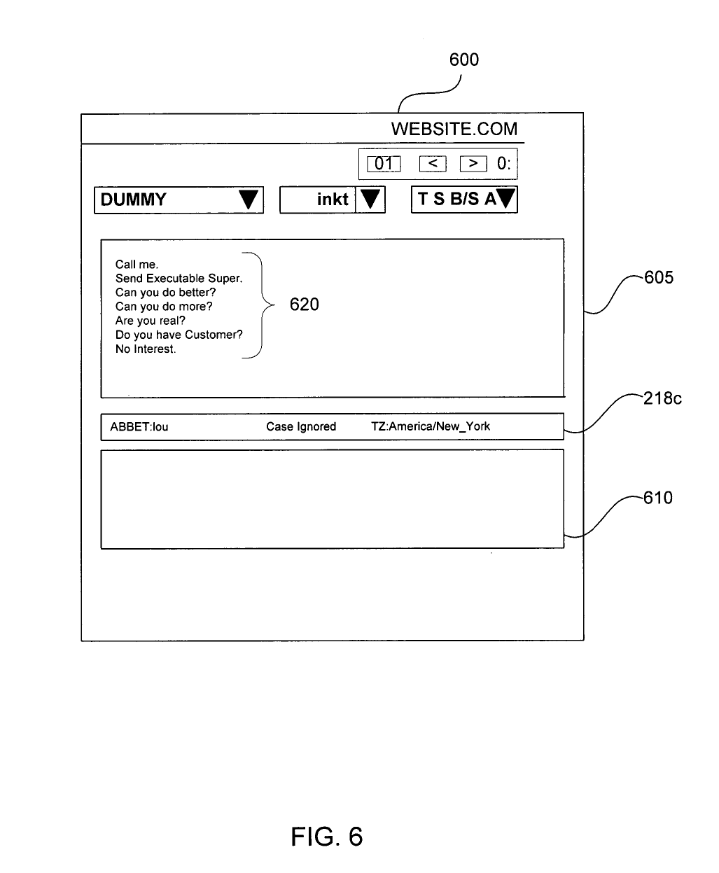

The system may be configured to allow additional message text to be appended to the reproduced data fields and the added time and originator identifiers. The additional text may be entered using an input keyboard. For example, user Lou may type in the text “Can you do better” on an input keyboard to be included in message line 602 (FIG. 5a). Alternatively or additionally, the system may be configured to present a list of canned alphanumeric text lines or terms from which a user may append suitable text to the reproduced data fields in the message line. FIG. 6 shows, for example, a web page display 600, which displays a list of canned alphanumeric text 620 in panel 605. Canned alphanumeric text 620 (e.g., “Can you do more?”, “Can you do better?”, “Are you real?”, etc.) may be a list of common queries or requests that institutional traders make of their broker/dealer counterparties. The user may select one of canned text 620 (e.g., by a mouse click) to be appended to reproduced data fields in line 602. This feature allows users to construct a message with minimal typing or keyboarding effort. For example, the text “Can you do better?” in message line 602 may have been appended by a single mouse click instead of character-by-character typing on an input keyboard.

After typing or appending suitable message text into message entry 602, the user may then instant message or send first message line in window 610 (e.g., message entry 602) to the originating broker/dealer through the system. The delivery of the instant message to the broker/dealer may be set up to occur, for example, by a mouse click on the message entry 602 or by suitable operation on an input keyboard. Alternatively, in instances where canned message text (e.g., list 620) is provided, the delivery of the instant message may be set to occur on selection of a canned message text (e.g., from list 620). In any instance, the instant message is delivered by the system to the IOI originating broker/dealer. FIG. 5b shows, for example, delivered first message entry 602 displayed in panel 610 at the computer terminal of salesman BBarker at broker/dealer Dummy.

The instant message entries may be sent to one individual or to a group of individuals at either a broker/dealer and/or at an institutional client. For example, the system may maintain a distribution list with computer addresses of salesmen or members of a team at a particular broker/dealer who are assigned to provide coverage for a particular institutional client. The instant messages (e.g., message entry 602) addressed to a broker/dealer from an institutional client automatically may be distributed to all members of the coverage team assigned to the institutional client. The distribution list may be maintained by a broker/dealer on its own mail systems or on a system server. If the list is maintained on the system server, the broker/dealer may be provided with system access to update or maintain the distribution list electronically (e.g., by transmission of an electronic file to the system).

The system also may maintain or store a complete transcript of all instant messaging sessions for each user. The stored transcripts may be titled and indexed in a directory. For convenience, the system may use the initial message or portions of the initial message (e.g., message line 602) of an instant messaging session as the session title or name. The directory may be sortable, for example, by time, or other criteria. The directory may be made available to a user through the system web pages. FIG. 5b shows, for example, a chat directory listing displayed in web page panel 610. The displayed chat directory, for example, lists two session titles 601 and 602. The titles 601 and 602 are listed in chronological order.

A chat directory title entry for an instant messaging session may contain sufficient identifying information to identify the instant messaging session. The identifying information may, for example, include the time stamp of the last update to session, the name of the session initiator, a portion of the initial message (e.g., the first 25 characters). Further, the directory entries may be visually or otherwise marked to indicate their status or the status of the instant messaging sessions they represent. The visual marking schemes may, for example, include color-coded backgrounds or fonts. In one exemplary scheme, entries on a yellow background might indicate that the corresponding instant messaging session has been updated by a session participant since it was last selected or visited by the user. A gray background might indicate that a messaging party has “quit” the session or that the session is terminated. The system may encode selectable links in the displayed titles by which a user can access the instant messaging session.

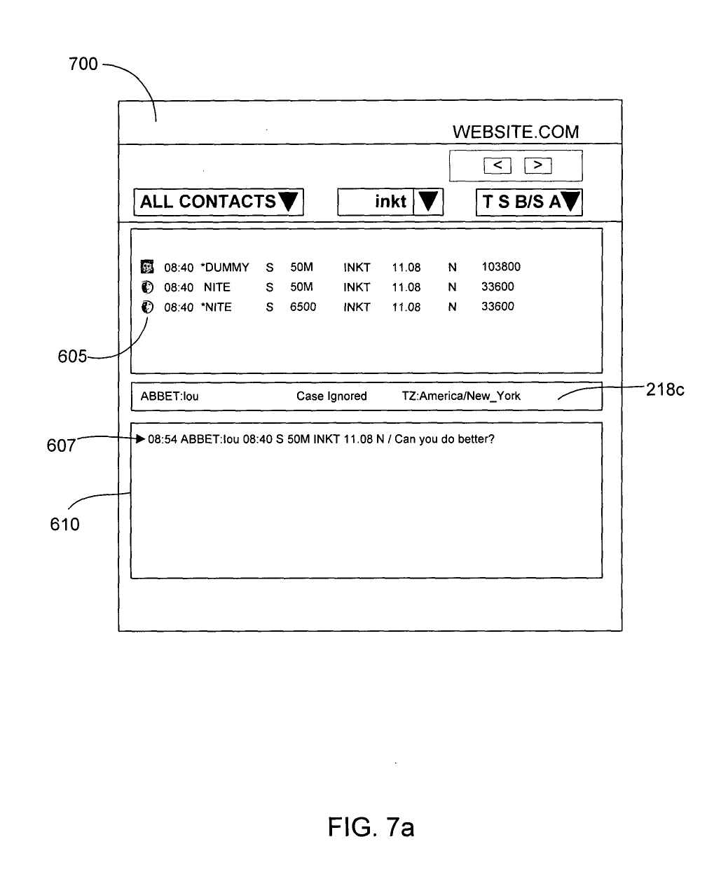

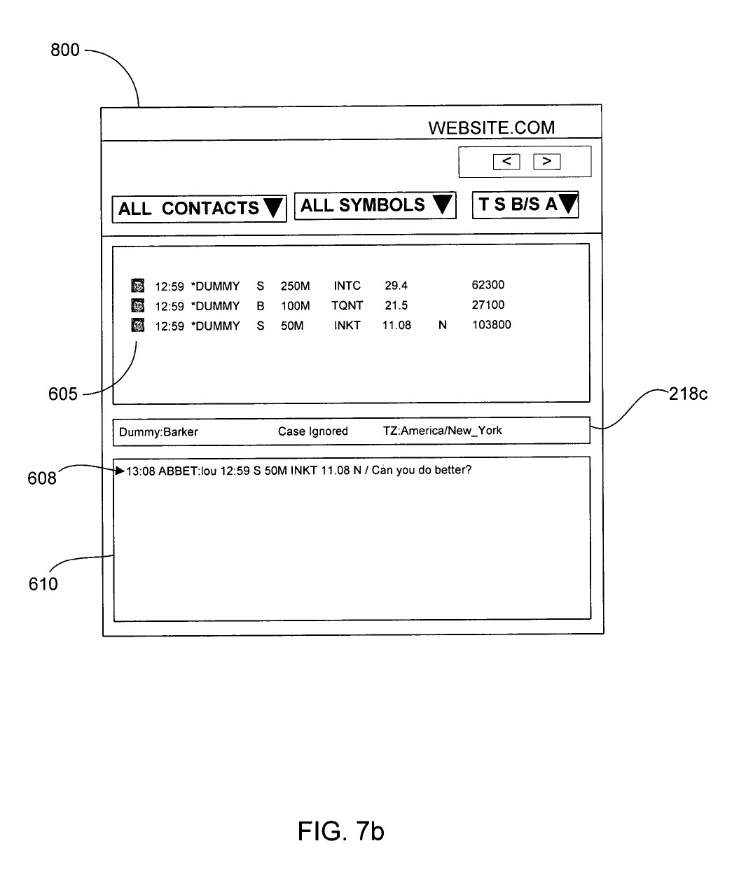

For purposes of further illustration, FIGS. 7a and 7b show additional web page displays 700 and 800 that are respectively displayed, for example, on the computer terminals of trader Lou at institutional client Abbet, and salesman Marker at broker/dealer Dummy. Panel 605 of page 700 shows the IOI data records received by trader Lou at Abbet from various brokers. Panel 605 of web page 800 shows the broker/dealer Dummy's self-originated IOI data records. Panels 610 of both web pages 700 and 800, respectively, show chat directory title entries 607 and 608 that correspond to a previous instant messaging session between the two parties.

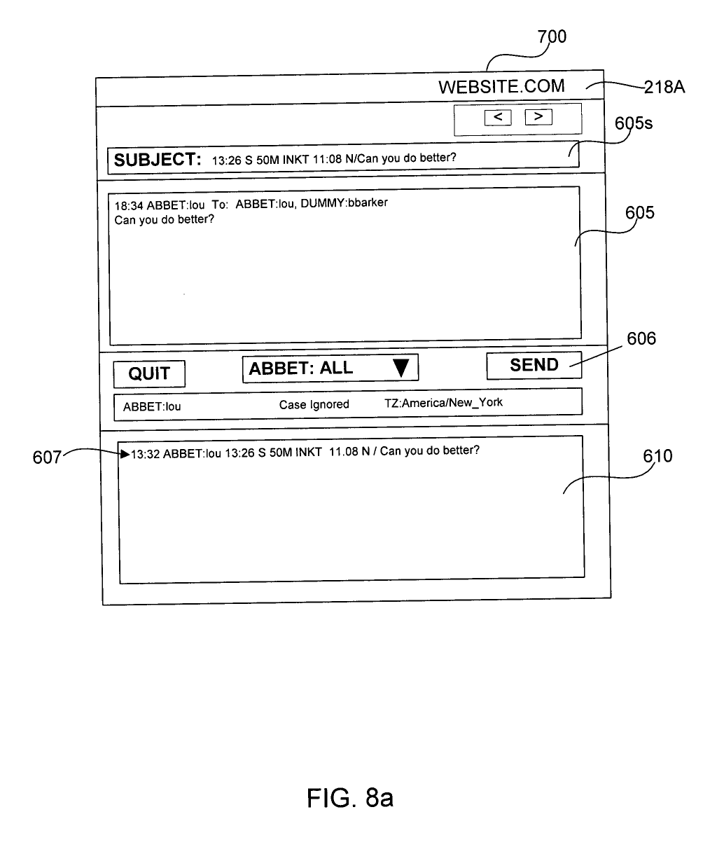

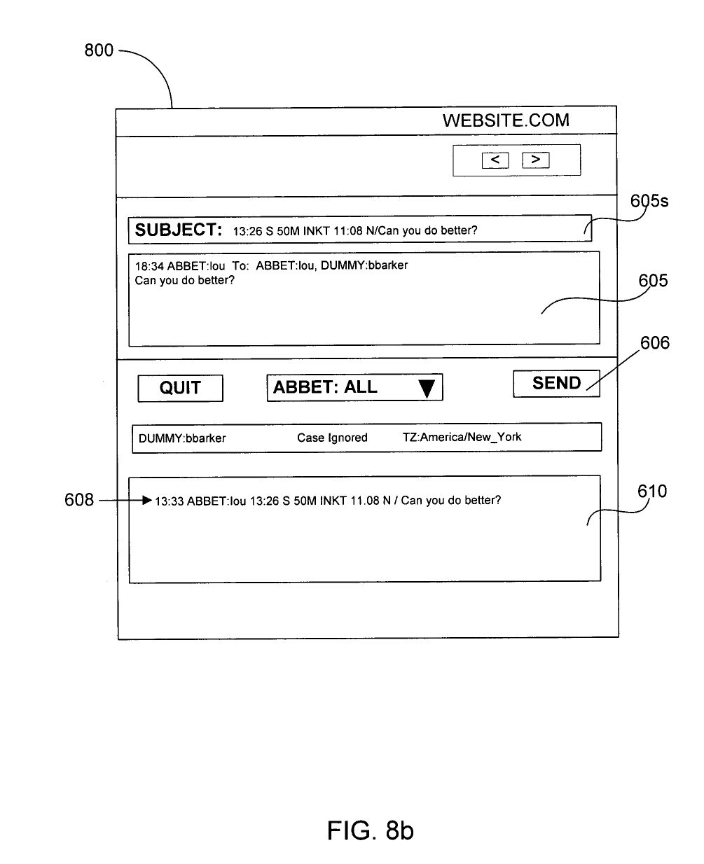

A user may access or reaccess a person-to-person instant messaging session by selecting and activating a chat directory title, for example, by a mouse click. In response to the user's selection, the system may bring the instant messaging session in view of the user. FIGS. 8a and 8b show, for example, instant messaging session views brought to display in panels 605 in response to each user's selections of chat directory title 607 and 608, respectively.

The system shows a transcript of the previously exchanged messages in the instant messaging session views (e.g., in panels 605). The system also may automatically load a portion of the chat directory title (e.g., 607 or 608) into headers, banners or subject lines (e.g., subject lines 605s) of the instant messaging session views.

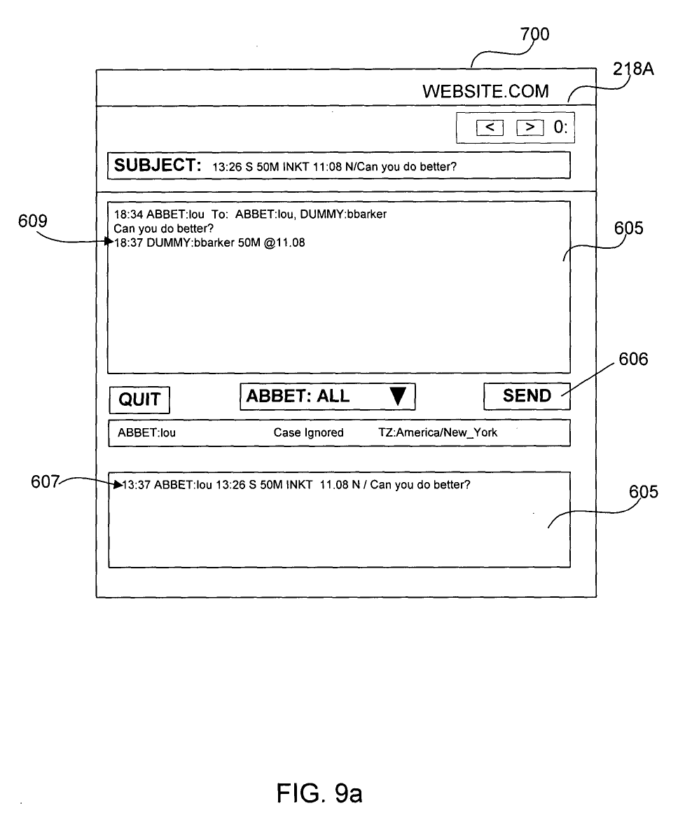

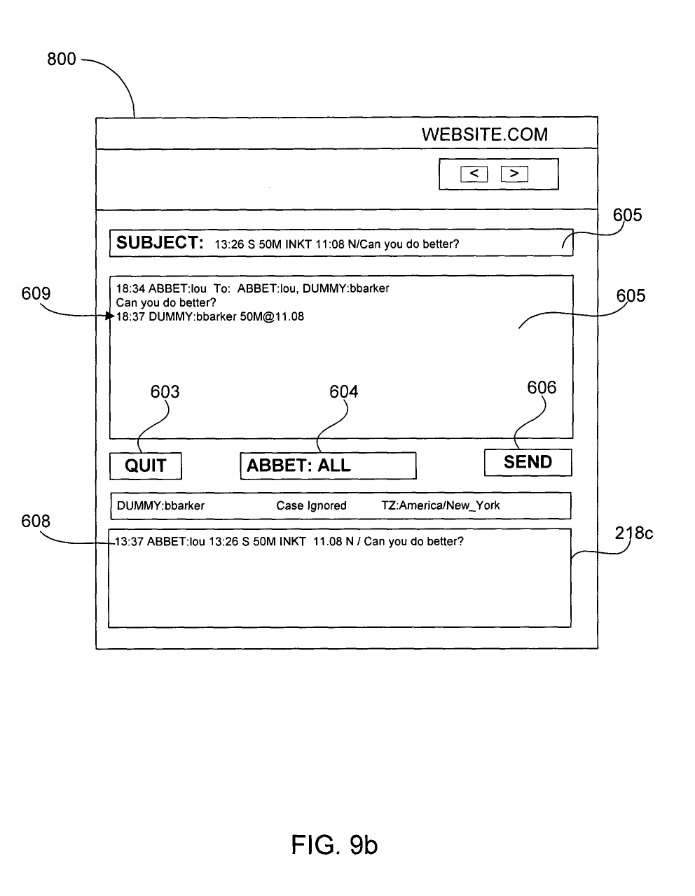

A user may input additional text to construct a new message or response in panel 605 using, for example, keyboard entry. For example, FIG. 9b shows a response (e.g., message 609) constructed by user bbarker. The user can send out this new message or response to the other party by activating, for example, a SEND indicator 606 provided in web page interfaces. In response to activation of SEND indicator 606, the system may add a time stamp and the name of the sender to the newly input text before sending the message to all session members. The system displays the sent message to all participants in their instant messaging session views. FIGS. 9a and 9b show, for example, message 609 displayed in the instant messaging session transcripts of both sender (e.g., DUMMY: bbarker) and recipient (e.g., Abbet: Lou). Message 609 includes alphanumeric message text “50M @11.08” with the prefix “18:37 DUMMY: bbarker” showing the time of the message and the identity of the sender, bbarker at Dummy.

A user may add other system users to an instant messaging session, for example, by addressing a sent message or its copies to these other users. A user may add other system users to a message distribution list, for example, by using an add-in feature provided by the system. This add-in feature may be used advantageously to communicate, for example, with other individuals of a team at the broker/dealer or at the institutional client when they are also involved in the transactions. The system appends a distribution list header (e.g., a CC: header) to the display of the instant messaging session (not shown) to make all participating parties aware of the extended membership of the session.

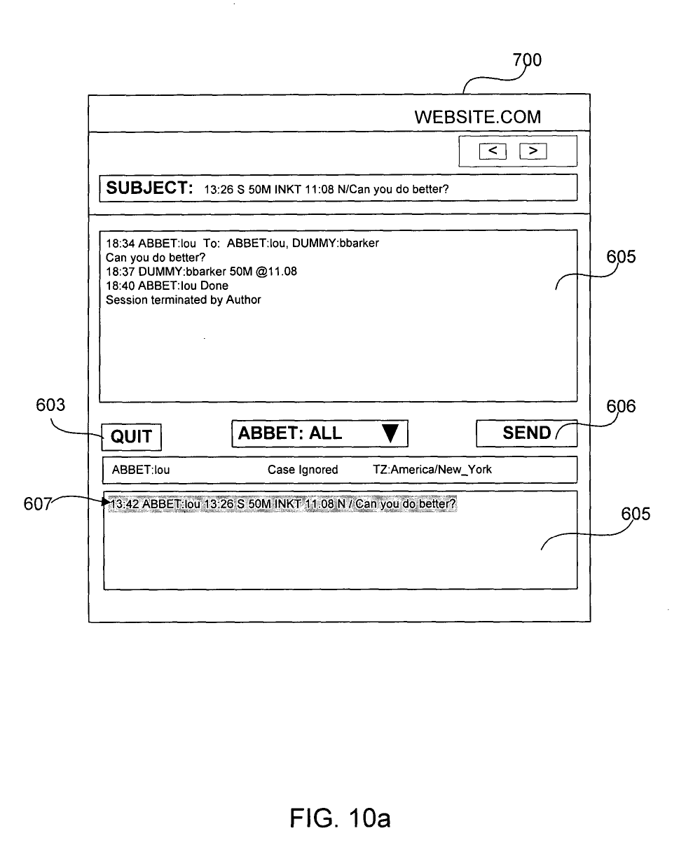

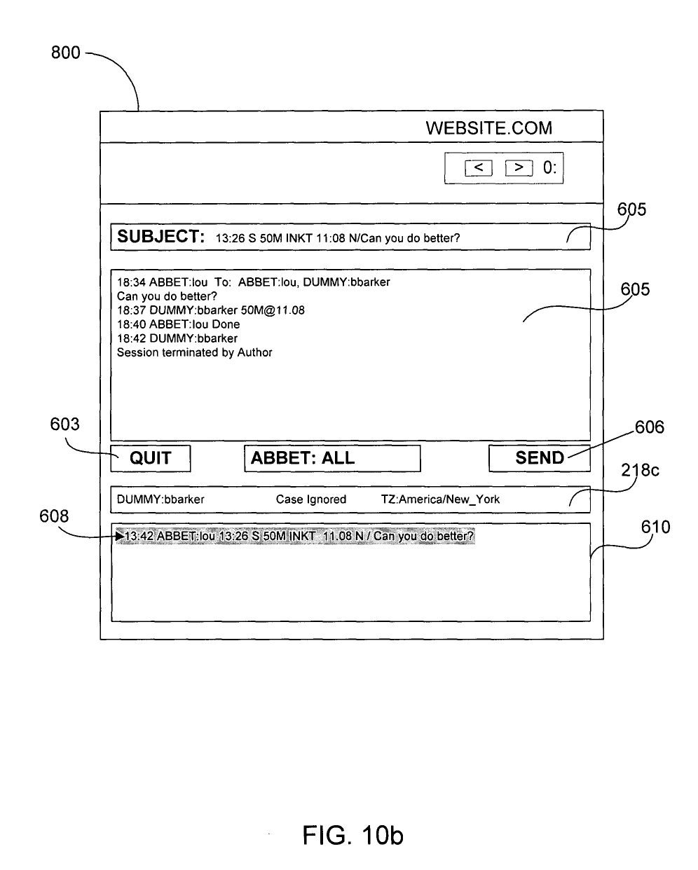

Any user participant may terminate the instant messaging session. The system may provide an indicator, for example, a QUIT indicator 603 of the session web page displays, for this purpose (e.g., FIG. 9b). In response to activation of QUIT indicator 603 by any of the session participants, the system terminates the instant messaging session and generates a termination message for all session participants. The system also marks (e.g., color codes) the chat directory title (e.g., titles 607 and 608) to indicate the closed status of the named instant messaging session. FIGS. 10a and 10b, show, for example, the terminating messages “Session terminated by Author” in panels 605, and a changed background color (e.g., gray) for chat directory titles 607 and 608 in panels 610.

The titles and transcripts of terminated instant messaging sessions may be preserved or stored by the system for historical analysis or review. The system provides the transcript of a terminated session for review to system users. For example, when a user selects a terminated session title (e.g., title 607) from the chat directory as described above, the system provides a transcript of the terminated session (e.g., in panel 605). However, the system may not allow updating, renewal, or the addition of new messages to a terminated session.

The system optionally may be configured as a gateway for communications with external systems. For example, the instant messaging sessions set up by the system may be linked to external instant messaging systems. The external instant messaging systems may, for example, be commercial systems such as those provided by America Online (AOL) or other commercial outfits. The system may maintain a database of the external screen names and/or the electronic addresses of external parties with whom communications through the system gateway may be authorized. A user of the system's instant messaging session may communicate or exchange messages with authorized external parties through the system gateway. For convenience, the system may thread external messages received by the system with internal messages in the session displays provided to the user.

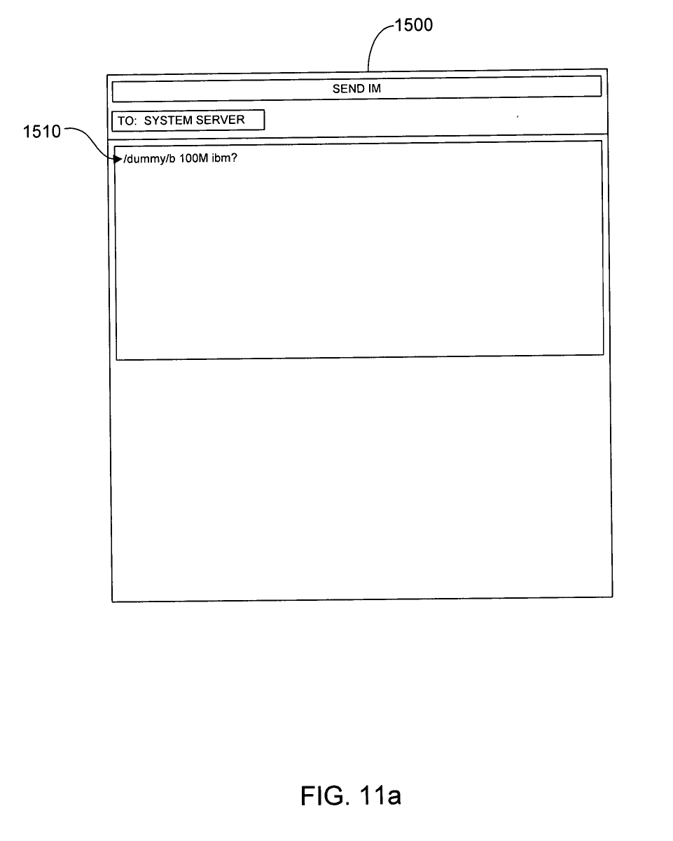

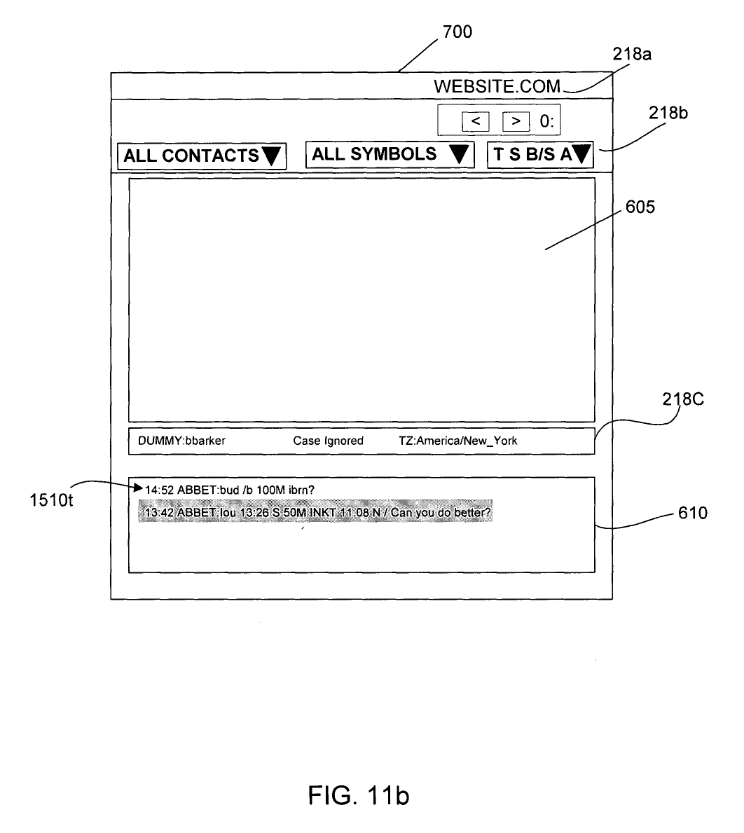

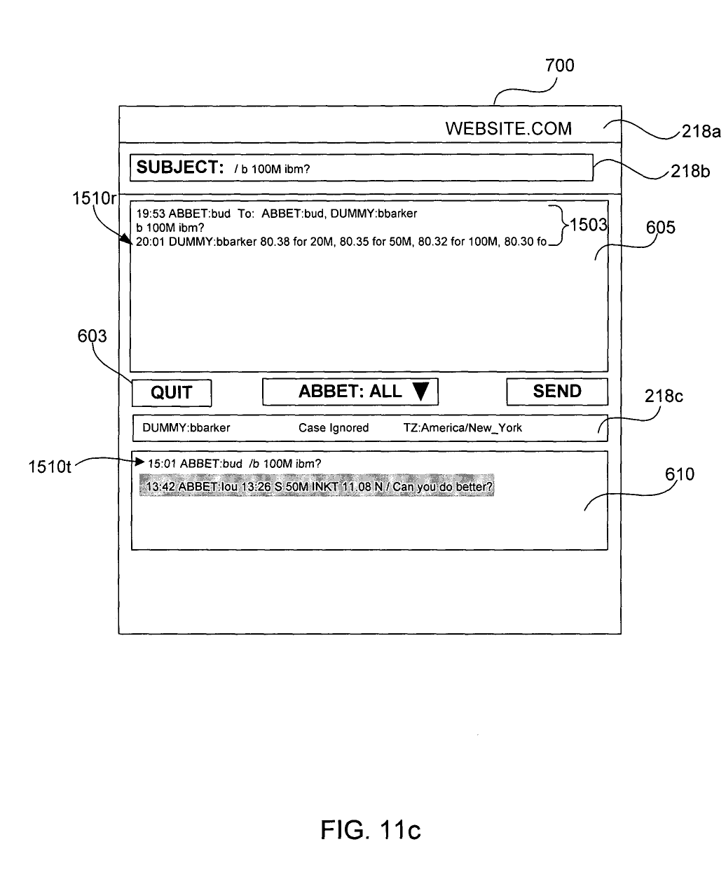

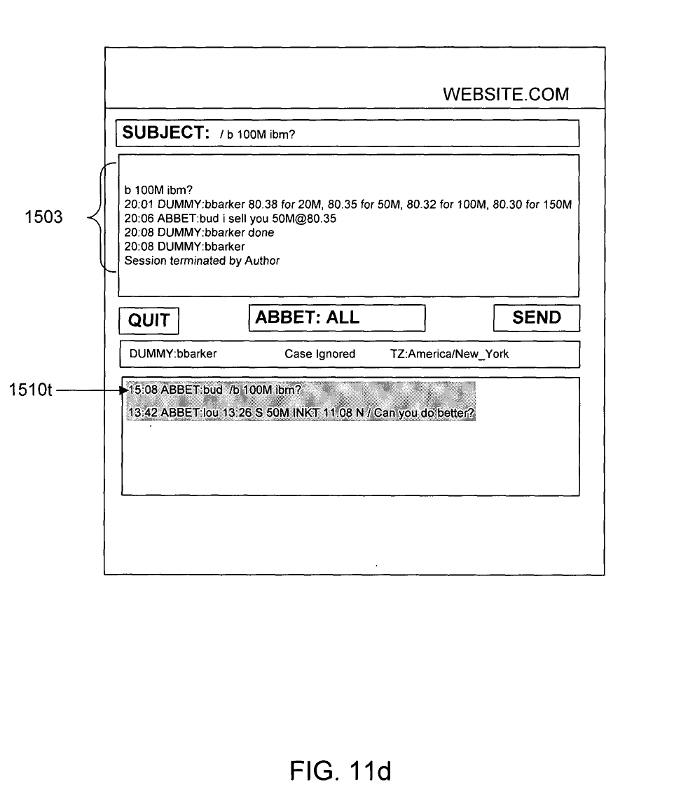

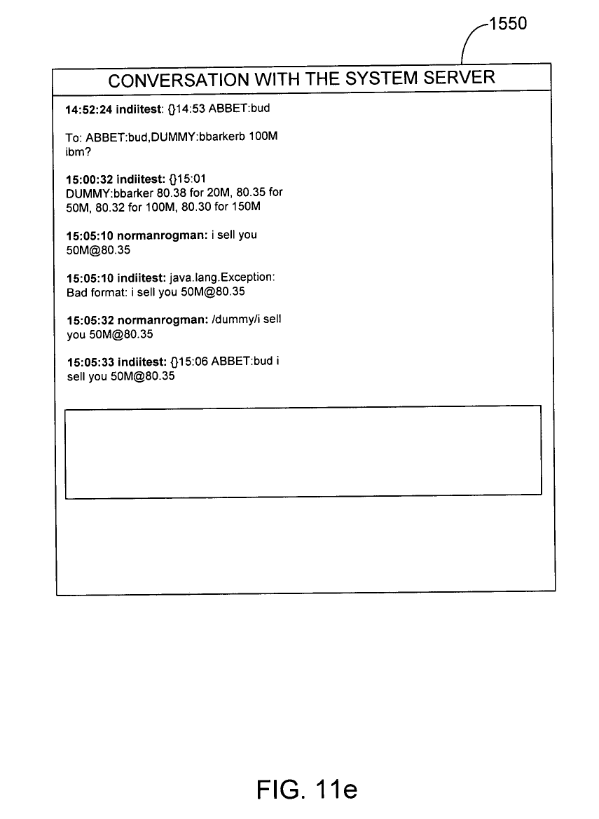

FIGS. 11a-11e show features of an exemplary linking of the system's instant messaging system with an external instant messaging system through the system gateway. In an example used for purposes of illustration, a trader “Bud” at Abbet uses an external messaging service (e.g., AOL) to communicate with salesmen at broker/dealer Dummy. Trader Bud has a AOL screen name “normanrogan.” This screen name is registered with the system database as an authorized external party.

FIG. 11a shows an AOL instant message screen 1500 with message 1510 prepared by Bud. Message 1510 contains a query (e.g., “b 100M ibm?”) for broker/dealer Dummy and is addressed to the system server. On receipt of an external message, the system verifies that normanrogan is an authorized party for external communications. On successful verification the system links or threads the external messaging service (e.g., AOL) to an internal instant messaging session with broker/dealer Dummy. The system server may title or name the internal instant messaging session by the first received message (as described above with reference to FIGS. 7-10). This title is entered in the system chat directory for the user BBarker at broker/dealer Dummy. FIG. 11b shows, for example, a display of chat directory title 1510t corresponding to the instant messaging session set up by the system in response to the external message from Bud (e.g., at time 14:52 hours). The system incorporates user-selectable contact links to the instant messaging session corresponding to displayed title 1510t.

User BBarker may (e.g., at time 15:01 hours) reply to the external query by selecting chat directory title 1510t, and then by activating the incorporated selectable links in a manner similar to that previously described (e.g., in the context of chat directories with reference to FIGS. 5-10). In response to the activation of the selectable links, the system displays the named instant messaging session to the user. FIG. 11c shows, for example, a session transcript 1503 including a reply message 1500r entered by salesman Bbarker at Dummy. The instant messaging session may be terminated as previously described by activation of QUIT indicator 603. On termination of the session, the system suitably marks the corresponding title 1510t (e.g., with color gray) to indicate a closed session.

All dialogue in the linked instant messaging sessions is threaded and kept together under the chat directory title. For example, FIG. 11d displays a transcript 1503 of the terminated session under chat directory title 1510t. Displayed transcript 1503 includes a record of both internal and external messages, which are threaded by counterparty and subject. A similar or equivalent transcript of the dialogue also may be displayed on the external messaging session. FIG. 11e shows, for example, a transcript 1550 that may be displayed on the external messaging service (AOL). Transcript 1550 is an equivalent of transcript 1503 (FIG. 11d).

In addition or as an alternate to the instant messaging schemes, the inventive system may include additional schemes or features that overcome or avoid the protocol limitations on the amount of information carried, for example, by conventional lOIs and super messages. A scheme involves linking the protocol messages with additional information files. This scheme advantageously allows augmentation of the information associated with protocol messages, while preserving the standard message text size for display. The protocol messages are distinctively tagged or marked, for example, so that the message recipients can be alerted to the presence of the additional information files. The protocol message displays may, for example, be color coded for this purpose. The recipients of the marked messages may, at their option, choose to review the attached information files.

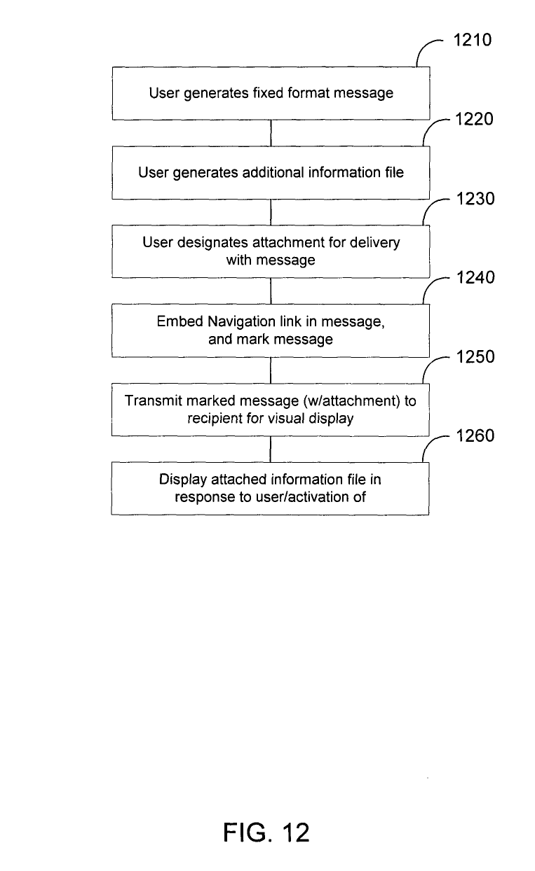

FIG. 12 is a flowchart of illustrative steps that may be involved in linking the protocol messages with additional information files, and marking the protocol messages to alert the recipient, and to display the additional information to the recipient. The steps shown in FIG. 12 are only illustrative and may be performed in any suitable order. In practice, some of the steps may be omitted, and additional steps that are not shown in FIG. 12 may be included.

At step 1210, a user generates a protocol formatted message for transmission to other system users. At step 1220, the user generates an additional information file. At step 1230, the user designates the additional information file for delivery as an attachment to the protocol message. At step 1240, a navigation link leading to the attachment is embedded or encoded in the protocol message, and the message is marked as having an attachment. At step 1250, the system transmits and makes the marked message available for visual display to the message addressees. At step 1260, the system displays the attached information file when an addressee activates the navigation link encoded in the visual display of the marked message.

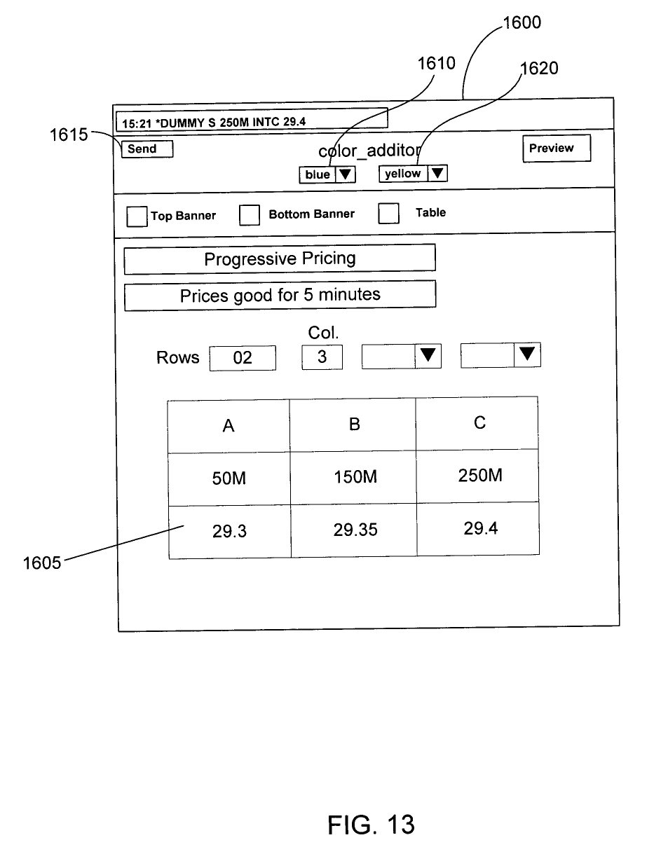

An implementation of this scheme is described herein with reference to FIGS. 13-15, using for illustration an example in which salesman BBarker at broker/dealer Dummy is selling a block of 250,000 shares of XYZ, Inc. BBarker wants to price the block of shares progressively. However, the standard messaging protocols allow only a single size and a single price to be encoded in a conventional IOI. Using the present system, Marker also may relay information on the progressive pricing along with the protocol IOI message to prospective counterparties.

A user may generate and attach additional information files to a message using, for example, a suitable data entry tool that may be provided by the system for the purpose. The data entry tool may be accessible through suitable web page indicators, for example, an indicator 301b on preference editor tool 300 (FIG. 4).

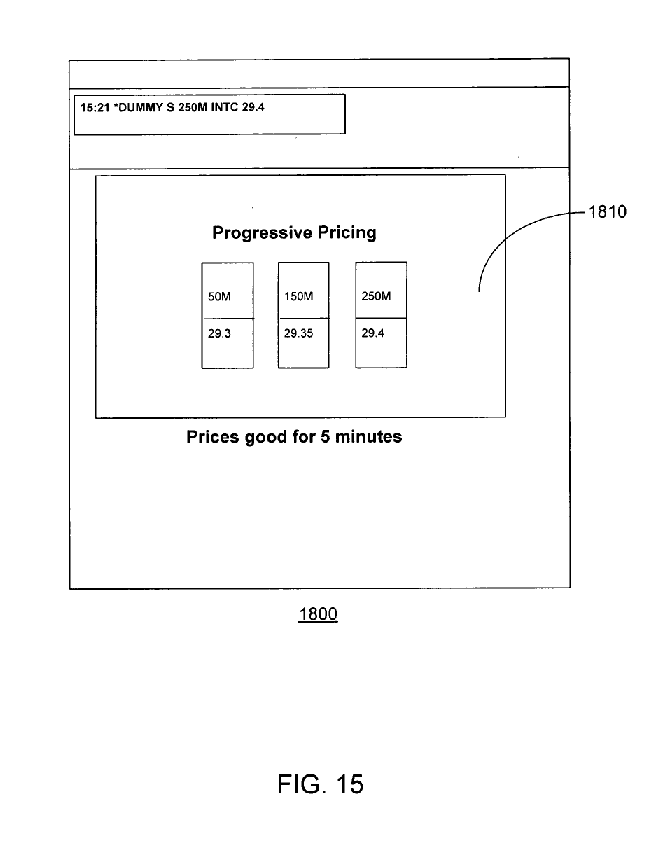

FIG. 13 shows an exemplary color addition tool 1600, which the system may provide to users for attaching additional information files to an IOI message. Tool 1600 may be activated, for example, by activating a “Supers” indicator 301b on preference editor screen 300 (FIG. 4). Tool 1600 may be configured, for example, to add the progressive pricing information as an attachment to the IOI message. Tool 1600 may, for example, be an HTML page generator, which is set up to display a table of data (e.g., table 1810, FIG. 15).

Tool 1600 may include conventional data entry fields or drop down boxes through which a user may enter alphanumeric data or text. FIG. 13 shows, for example, columns and row data entry fields 1605 in which data corresponding to the progressive pricing plan offered by salesman BBarker at Dummy has been entered.

Tool 1600 also include data entry fields or drop down menus 1610 and 1620 through which a user may add color attributes to an IOI. The color attributes in menu 1610 and 1620 may relate to the status of the IOI—yellow for currently updated, gray for terminated, etc. The color attributes in menu 1610 and 1620 may be used to tag or mark visual displays of the IOI to indicate the attachment of additional information. The color entries in the drop down menus may be selected automatically or manually. FIG. 13 shows, for example, drop down menu 1610, which is automatically set to “blue” when tool 1600 is activated to tag or designate the IOI as having an attachment.

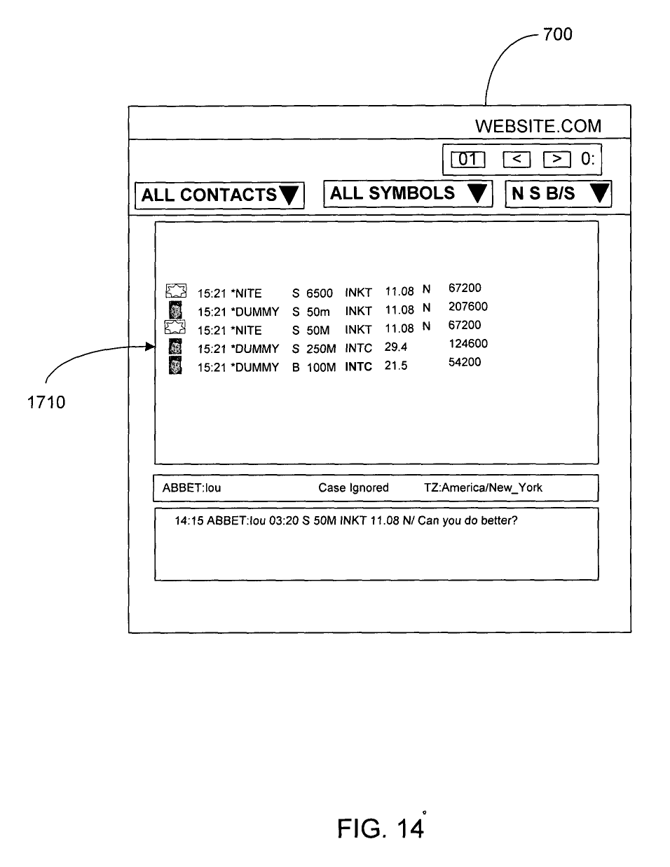

After data entry and tagging, BBarker may broadcast the tagged IOI by activating, for example, a “send” indicator 1615. In response to this activation, the system distributes the tagged IOI with its attached file to other system users. This tagged IOI is displayed on the recipient's computer terminals, for example, with a colored or otherwise distinguishing font or background. FIG. 14 shows, for example, tagged IOI 1710 received, for example, by Lou at the trading desks of Abbet. The recipient (e.g., Lou) may select a tagged IOI, for example, by a mouse click. In response, the system automatically displays an .html or .rtf page showing the additional information. FIG. 15 shows, for example, an html page display 1800 of the progressive pricing data table 1810.

It will be understood that the foregoing is only illustrative of the principles of the invention and that various modifications can be made by those skilled in the art without departing from the scope and spirit of the invention, which is limited only by the claims that follow.

1. A method for augmenting the information content of electronic messages between parties trading in financial instruments, wherein the electronic messages have display formats and sizes limited by industry protocol, the method comprising:
receiving an electronic message from a sender party;
transmitting the electronic message to a recipient party for fixed format display;
embedding an activation link in the displayed message, wherein the link leads to an information augmentation; and
providing information augmentation in response to the recipient party's activation of the link.

2. The method of claim 1 wherein receiving an electronic message from a sender party comprises receiving an indication of interest message for trading financial instruments.

3. The method of claim 1 wherein receiving and transmitting the electronic messages comprise displaying the messages on web pages accessible to the parties.

4. The method of claim 1 wherein transmitting messages further comprises adding time stamps and sender identification to the received messages.

5. The method of claim 1 wherein embedding an activation link comprises embedding HTML links in the displayed message.

6. The method of claim 1 further comprising storing electronic messages between the parties as data records in a database.

7. The method of claim 6 further comprising making a subset of data records available to a party for viewing on web page displays.

8. The method of claim 7 wherein the web page display views are based on customizable templates, further comprising storing customized web page templates.

9. The method of claim 1 wherein the information augmentation comprises providing person-to-person contact.

10. The method of claim 9 wherein providing a person-to-person contact comprises providing an instant messaging session between the between the sender party and the recipient party in response to the latter's activation of the activation link in the displayed message.

11. The method of claim 10 wherein the sender party is associated with a first coverage team including at least the sender party, wherein the recipient party is associated with a second coverage team including at least the recipient party, and wherein the information augmentation comprises providing an instant messaging session between the first and second coverage teams in response to the latter's activation of the activation link in the displayed message.

12. The method of claim 10 wherein the instant messaging sessions involving a party are given names and the names are entered in a directory.

13. The method of claim 12 further comprising displaying the directory of names to the party, and embedding a user-selectable link leading to named instant messaging session in its displayed name.

14. The method of claim 1 wherein the information augmentation comprises an additional information file attached to the received message.

15. The method of claim 14 further comprising providing a tool to generate and attach an additional information file to the message.

16. The method of claim 14 wherein transmitting the electronic message to a recipient party for fixed format display comprises marking the message to indicate the presence of the attached additional information file.

17. The method of claim 14, wherein providing the information augmentation in response to activation of the link comprises displaying the attached additional information file as an HTML page.

18. A system for augmenting the information content of electronic messages between parties trading in financial instruments, wherein the electronic messages have restricted display size according to financial industry protocols, the method comprising:
means for receiving an electronic message from a sender party;
means for transmitting the electronic message to a recipient party for restricted size display according to financial industry protocols;
means for embedding an activation link in the restricted size display, wherein the activation link leads to an information augmentation; and
means for providing the information augmentation in response to activation of the link.

19. The system of claim 18 wherein means for transmitting messages further comprises means for adding time stamps and sender identification to the received messages.

20. The system of claim 18 wherein the means for receiving and the transmitting messages comprise means for displaying the messages on web pages accessible to the parties.

21. The system of claim 18 further comprising means for storing electronic messages between the parties as data records in a database.

22. The system of claim 21 further comprising means for making a subset of data records available to a party for viewing on web page displays.

23. The system of claim 22 wherein the web page display views are based on customizable templates, further comprising means for storing customized web page templates.

24. The system of claim 18 wherein the means for providing information augmentation comprises means for providing person-to-person contact.

25. The system of claim 18 wherein the means for providing the information augmentation comprises means for providing an instant messaging session between the sender party and the recipient party in response to the latter's activation of the activation link in the displayed message.

26. The system of claim 25 wherein the sender party is associated with a first coverage team including at least the sender party, wherein the recipient is associated with a second coverage team including at least the recipient party, and the means for providing the information augmentation comprises means for providing an instant messaging session between the two coverage teams in response to the recipient party's activation of the activation link in the displayed message.

27. The system of claim 25 further comprising means for listing names of the instant messaging sessions involving a party in a directory.

28. The system of claim 27 further comprising means for displaying the directory listing of names to the party, and embedding a user-selectable link leading to named instant messaging session in its displayed directory name.

29. The system of claim 18 further comprising a tool to generate and attach an additional information file to a message.

30. The system of claim 29 wherein the means for transmitting the message to a recipient party for restricted size display comprises means for marking the message indicate the presence of the attached additional information file.

31. The system of claim 29, wherein the means for providing the information augmentation in response to activation of the link comprises means for displaying the attached addition information file as an HTML page.

32. A trading message platform for providing industry protocol-governed messages over a computer network, comprising:
a plurality of access devices coupled to the computer network, wherein each access device of the plurality of access devices is associated with a user of a plurality of users; and
a server coupled to the computer network, wherein the server is configured to process the messages sent and received amongst the users and to provide web pages from which a user may send a message, view a protocol-governed message display, and respond to a received message display, wherein the received message display includes a navigation link leading to additional information related to the protocol-governed message.

33. The trading message platform of claim 32 wherein the computer network is the Internet.

34. The trading message platform of claim 32 wherein the server is configured to time stamp and add sender identification to the messages sent and received amongst the users.

35. The trading message platform of claim 32 wherein the server is further configured to store the sent and received messages amongst the parties as data records in a database.

36. The trading message platform of claim 35 wherein the server is of further configured for making a subset of data records available to a user for viewing.

37. The trading message platform of claim 32 wherein the server is configured to set up an instant messaging between a sender and a recipient of a message when the latter activates the navigation link leading to additional information in the displayed message.

38. The trading message platform of claim 32, wherein the sender party is associated with a first coverage team including at least the sender party, wherein the recipient is associated with a second coverage team including at least the recipient party, and wherein the server is configured to set up an instant messaging session between the coverage teams associated with the sender and the recipient when the latter activates the navigation link leading to additional information in the displayed message.

39. The trading message platform of claim 37 wherein the server is configured to list names of the instant messaging sessions involving a user in a directory.

40. The trading message platform of claim 39 wherein the server is further configured to display the list of names in a directory to the user and for embedding a user-selectable link leading to named instant messaging session in its displayed directory name.

41. The trading message platform of claim 32 further comprising a tool to generate and attach an additional information file to a message.

42. The trading message platform of claim 41 wherein the server is configured to mark the display of the message on the access devices to indicate the presence of the attached additional information file.

43. The trading message platform of claim 41 wherein the server is configured to display the additional information file as an HTML page in response to activation of the link leading to additional information.

44. The trading message platform of claim 32 further comprising a gateway for receiving messages from and sending messages to an external messaging service.

45. A format for an electronic trading message comprising:
a fixed number of alphanumeric data fields, wherein the number is fixed according to financial industry protocols;
an identification of a sender of the message; and
an activation link for an instant messaging session between a recipient of the message and the sender of the message.

46. The format of claim 45 wherein the message is an indication of interest message and wherein the financial industry protocols are the Financial Information Exchange protocols.

47. The format of claim 45 wherein the identification of the sender is linked to identifications of a coverage team associated with the sender, wherein the coverage team includes at least the sender, and wherein the activation link activates an instant messaging session between the recipient of the message and the coverage team.
